(19) United States
(12) Patent Application Publication
(10) Pub. No.: US 2026/0026523 A1
(43) Pub. Date: Jan. 29, 2026

(54) DEVICE AND METHOD FOR AUTONOMOUS TEMPERATURE REGULATION AND HEAT PRESERVATION, BEVERAGE PREPARATION DEVICE AND MILK COLLECTION DEVICE

(71) Applicant: SETI Tech (Chengdu) Co., Ltd., Chengdu (CN)

(72) Inventor: Song QU, Chengdu (CN)

(73) Assignee: SETI TECH (Chengdu)Co, Ltd., Chengdu (CN)

(21) Appl. No.: 19/344,453

(22) Filed: Sep. 29, 2025

Related U.S. Application Data
(63) Continuation of application No. PCT/CN2024/085333, filed on Apr. 1, 2024.

(30) Foreign Application Priority Data
Mar. 31, 2023 (CN) 202310343796.X

(51) Int. Cl. A23B 11/14; A23B 11/12

(52) U.S. Cl. CPC A23B 11/14; A23B 11/12

(57) ABSTRACT

The present invention relates to an non-energy-dependent temperature regulation and insulation device and method, as well as a portable beverage preparation device and milk collection device. The temperature regulation and insulation device comprises a temperature regulation portion and an air storage portion. The temperature regulation portion comprises an inner interlayer; an outer interlayer surrounding the inner interlayer; and a receiving cavity defined by the inner interlayer. The inner interlayer communicates with the air storage portion. The device of the present invention can be used in environments where mature raw milk collection and collection equipment is unavailable, effectively collecting dispersed raw milk while maintaining the stability and safety of the raw milk.

### CROSS-REFERENCE TO RELATED APPLICATIONS

This is a continuation of International Patent Application No. PCT/CN2024/085333 filed on Apr. 1, 2024, which claims priority to Chinese patent application No. 202310343796.X filed on Mar. 31, 2023. The disclosures of the above-referenced applications are hereby incorporated by reference in their entirety.

### BACKGROUND

China boasts the fastest-growing dairy production and consumption globally. In 2021, national dairy production reached 30.317 million tons, a year-on-year increase of 9.4% (compared to 2.8% in 2020). Holsteins are the primary dairy cattle breed in China, with approximately 5 million head currently in the herd. Dairy products are a crucial strategic commodity, but China's raw milk self-sufficiency rate was only around 65% in 2019, far short of the national safety line of 70%.

### SUMMARY

The present invention relates to a device and method for autonomous temperature regulation and heat preservation, as well as a portable beverage preparation device and a milk collection device comprising the device.

The present invention provides an non-energy-dependent temperature regulation and heat preservation device and method, as well as a portable beverage preparation device and a milk collection device comprising the temperature regulation and heat preservation device, so as to improve the utilization rate of raw milk produced by free-range dairy cows.

According to one aspect of the present invention, a non-energy-dependent temperature control and heat preservation device is provided, comprising a temperature control portion and a gas storage portion; wherein the temperature control portion comprises: an inner interlayer; an outer interlayer surrounding the inner interlayer; and a receiving cavity defined by the inner interlayer;
wherein, the inner interlayer is communicated with the gas storage part.

According to another aspect of the present invention, a non-energy-dependent temperature control and heat preservation method is provided, which comprises utilizing the vaporization of liquefied gas or the sublimation of solidified gas to cool an object to be cooled.

According to another aspect of the present invention, a milk collecting and temperature regulation device is provided, comprising a milking unit and a heat exchange unit, wherein the milking unit comprises a power pump and one or more suction heads connected to the power pump.

According to another aspect of the present invention, a portable milk collection and temperature regulation device is provided, comprising: a power generation module including a power generation unit and an energy storage unit, a temperature regulation and heat preservation device, and a milking module including a milking unit, a filter unit and a motor; wherein the power generation unit is electrically connected to the motor and to an auxiliary temperature regulation component of the temperature regulation and heat preservation device.

According to another aspect of the present invention, a method for collecting and regulating milk temperature is provided, comprising the steps of: supplying power to a motor and driving the motor so that a milking unit connected to the motor milks to obtain raw milk; and conveying the raw milk to a temperature regulation and heat-insulating device that is not energy-dependent, and cooling the raw milk by vaporizing liquefied gas or sublimating solidified gas.

According to another aspect of the present invention, a portable beverage preparation device is provided, comprising a holding portion for holding beverage components and a temperature regulation portion; wherein the temperature regulation portion holds liquefied gas or solidified gas, and, as needed, delivers the liquefied gas to the holding portion to cool the holding portion; or the temperature regulation portion comprises a self-heating material package to heat the holding portion.

According to another aspect of the present invention, a portable automatic milk collection device is provided, comprising the temperature regulation and heat preservation device described above.

According to another aspect of the present invention, a method for monitoring and managing grazing and milking is provided, comprising the steps of:
selecting pastoral areas and confirming pastoral area information;
receiving the number of dairy cows in the selected pasture and location information of each dairy cow;
checking whether the positioning information is within the stored selected pastoral area; and
determining whether to send a control signal based on the check result, wherein the control signal is used to control the status of the cow.

According to another aspect of the present invention, there is provided a grazing and milking monitoring and management device, comprising the following modules.

A receiving module is used to receive information to be processed related to dairy cows, milking devices, and temperature control and insulation devices.

A checking module, used to check the to-be-processed information related to the dairy cow, the milking device and the temperature regulation and heat preservation device with corresponding preset values, and determine whether a control signal needs to be sent.

The sending module is used to send a control signal to prompt the cows to return to the selected pasturing area or distribution center.

According to another aspect of the present invention, there is provided an electronic device, comprising:
a processor; and
a memory communicatively connected to the processor.

The memory stores instructions that can be executed by the processor, and the instructions are executed by the processor to enable the processor to perform the above method.

According to another aspect of the present invention, a non-transitory computer-readable storage medium storing computer instructions is provided, wherein the computer instructions are used to enable the computer to execute the above-mentioned grazing milking monitoring and management method.

According to another aspect of the present invention, a computer program product is provided, comprising a computer program, wherein the computer program implements the above-mentioned grazing and milking monitoring and management method when executed by a processor.

The technology according to the present invention solves the problem of lowering the temperature of the collected raw milk during storage and transportation when there are no conditions for intensive mechanical and automated collection, improves the quality of the transported milk, and extends the shelf life of the raw milk.

It should be understood that the content described in this section is not intended to identify the key or important features of the embodiments of the present invention, nor is it intended to limit the scope of the present invention. Other features of the present invention will become readily understood through the following description.

### BRIEF DESCRIPTION OF THE DRAWINGS

The accompanying drawings are provided for a better understanding of the present invention and do not constitute a limitation of the present invention.

FIG. 1 is a schematic longitudinal cross-sectional view of a temperature regulation and heat preservation device according to one embodiment of the present invention;

FIG. 2 is a schematic diagram of a pillow-plate jacketed structure of an inner layer of a temperature regulation and heat-insulating device according to the present invention;

FIG. 3 is a schematic diagram of the distribution of welding points of the pillow-plate jacketed structure of the inner interlayer of the temperature regulation and heat insulation device according to the present invention;

FIG. 4 is a schematic diagram of welding a pillow-plate jacketed structure of an inner layer of a temperature regulation and heat-insulating device according to the present invention;

FIG. 5 is a schematic diagram of the coil structure of the inner interlayer of the temperature regulation and heat preservation device according to the present invention;

FIG. 6 is a first schematic diagram of an auxiliary temperature regulation component according to another embodiment of the present invention;

FIG. 7 is a second schematic diagram of an auxiliary temperature regulation component according to another embodiment of the present invention;

FIG. 8 is a schematic longitudinal cross-sectional view of a cooling and fresh-keeping device according to another embodiment of the present invention;

FIG. 9 is a schematic longitudinal cross-sectional view of a portable beverage refrigeration and aeration device according to another embodiment of the present invention;

FIG. 10 is a schematic diagram of a negative pressure filtration device according to one embodiment of the present invention;

FIG. 11 is a schematic diagram of the negative pressure formation principle of the negative pressure filtration device of FIG. 10;

FIG. 12 is a schematic diagram of a positive pressure filtration device according to one embodiment of the present invention;

FIG. 13 is a schematic diagram of a gas adsorption recovery device according to one embodiment of the present invention;

FIG. 14 is a schematic diagram of a milk collection and temperature conditioning device according to an embodiment of the present invention;

FIG. 15 is a schematic diagram of a motor for a peristaltic pump that may be used in the milk collection and temperature regulation device shown in FIG. 14;

FIG. 16 is a schematic diagram of a milk collection and temperature conditioning device according to another embodiment of the present invention;

FIG. 17 is a schematic diagram of a portable milk collection and temperature regulation device according to an embodiment of the present invention;

FIG. 18 is a schematic diagram of a gas-driven cleaning device according to an embodiment of the present invention;

FIG. 19 is a schematic diagram of a portable beverage preparation device according to an embodiment of the present invention;

FIG. 20 is a schematic diagram of a temperature regulation and heat preservation method according to an embodiment of the present invention;

FIG. 21 is a schematic diagram of an autonomous temperature control and insulation method according to another embodiment of the present invention;

FIG. 22 is a first schematic diagram of autonomous temperature regulation and heat preservation methods according to different embodiments of the present invention;

FIG. 23 is a second schematic diagram of autonomous temperature regulation and heat preservation methods according to different embodiments of the present invention;

FIG. 24 is a schematic diagram of a method for collecting and tempering milk according to an embodiment of the present invention;

FIG. 25 is a schematic diagram of a method for monitoring and managing grazing and milking according to an embodiment of the present invention;

FIG. 26 is a first schematic diagram of the mobile phone APP interface according to the grazing and milking monitoring and management method shown in FIG. 25;

FIG. 27 is a second schematic diagram of the mobile phone APP interface according to the grazing and milking monitoring and management method shown in FIG. 25; and

FIG. 28 is a third schematic diagram of the mobile phone APP interface according to the grazing and milking monitoring and management method shown in FIG. 25.

### DETAILED DESCRIPTION

Although China's raw milk self-sufficiency rate is low, its vast domestic milk resources remain largely undeveloped and underutilized. For example, China boasts the largest yak population in the world. According to 2019 statistics, the country had 16.21 million yaks, accounting for over 90% of the world's total yak population. While the country's yak population is more than three times the number of dairy cows, yak milk contributes very little to the country's dairy product supply. In 2016, national commercial yak milk production was only 112,000 tons. Yak milk products are primarily consumed in Tibetan areas, with a small amount sold to inland areas and virtually no exports. As a unique species and pillar industry in Tibetan areas, yaks and yak milk products are an important source of livelihood and income for Tibetan herders, playing a crucial role in helping them escape poverty. Therefore, the effective development and utilization of yak milk is of great social and economic significance. The main reason for the low level of commercialization of yak milk products is that their production costs are significantly higher than those of conventional cow's milk. Conventional milk production relies on artificial breeding, conception, reproduction, standardized feed, and intensive collection and management, resulting in high, long-term, and stable milk production. Yaks, in contrast, graze naturally, feed on grass, conceive, reproduce, and lactate naturally. Consequently, yak milk production is seasonal, with a short lactation period, low milk yields, and significant fluctuations. The average daily milk production of a dairy cow can reach 40-60 kilograms, over 30 times that of a yak. The lactation period for a dairy cow can reach 300 days, twice that of yak milk. This significant disparity in milk production creates a fundamental cost disadvantage for yak milk production. Furthermore, the vast and scattered pastures where yaks graze make it difficult to collect, gather, and transport yak milk, further driving up the cost of yak milk production.

A major factor hindering the development of the yak milk industry is the lack of a yak milk collection and transportation system specifically designed for the specific needs of yak milk production. Existing dairy collection and processing equipment is designed and manufactured to accommodate modern, standard dairy production models. Cows are raised and milked in large, centralized facilities, with continuous, localized batch processing. Yak milk processing companies have copied the centralized, large-scale production model of traditional dairy companies, which in turn increases production costs and product safety and quality risks. Yak milk production is seasonal, with a short lactation period and low milk yield. Pastures are scattered and extensive, making milk hygiene and safety testing difficult. Collection equipment lack effective cleaning methods, and transportation routes are difficult. Consequently, intensive mechanized automated collection is unsuitable, resulting in extremely high costs for yak milk collection and transportation. Yak milk processing requires exploring new, smaller, and localized approaches to maximize the benefits of yak milk, minimizing its shortcomings and maximizing its potential.

The industrial development of yak milk represents a collision and fusion of primitive and modern elements, forging a sustainable path that balances tradition with modernization, and integrates industrial economic development with environmental and resource protection. Unlike other modern dairy industries, where milk collection and management are highly automated from the very beginning, seamlessly integrating milk processing and production, the yak's physiological characteristics and free-range lifestyle across vast grasslands prevent centralized rearing, mechanical milking, or pipeline collection and transportation. Consequently, significant physical distance and technological gaps exist between the front-end collection and management and the back-end processing and production of yak milk. Overcoming this barrier and effectively and rationally connecting the front and back ends has been a significant challenge for the yak dairy industry.

At the forefront of the entire supply chain, local herders and their yaks have well-preserved their traditional production and lifestyle. Locally, pastures are contracted to individual households, with each household allocated designated warm-season and cold-season pastures. As the seasons change, herders follow their yaks, switching between warm-season and cold-season pastures. Yaks follow the laws of natural selection, grazing naturally, foraging naturally, conceiving naturally, giving birth naturally, nursing naturally, and milking naturally, all while being milked by hand. At the back end of the supply chain, the yak dairy industry utilizes modern production technology, equipment, and management methods to produce yak milk products. This represents a clash between primitive and modern production methods. Bridging the two ends requires overcoming significant obstacles and difficulties. Because the production methods span the agricultural and industrial revolutions, there is a generational gap in technology, production concepts, and philosophies. However, the overall trend is to bring the modern production method to the deep in the grassland, gradually influencing the more primitive production methods. Traditional ways of life and production are extremely vulnerable to modern industrial civilization. How to rationally utilize the convenience and advantages of modern industrial civilization while protecting traditional ways of life and production, thereby preserving the yak species and its traditional way of life in Tibet for thousands of years, presents a challenge of wisdom. In some ways, protecting the traditional way of life and production of Tibetan herders is also protecting the yak resource and the natural environment. Therefore, developing environmentally friendly yak milk collection, storage, and transportation equipment systems that are compatible with traditional ways of life and production, meet modern food hygiene and safety requirements, and are environmentally friendly is of great social and economic significance.

The production and processing methods of yak milk in Tibet are actually common and universal in many underdeveloped regions of the world, such as Central Asia, South America and Africa. The Gates Foundation and the University of Hoffenheim in Germany have both made active attempts to this field. The Gates Foundation has developed the Mazzi bucket, which can be used for collecting, storing and transporting milk. Its wide opening solves the problem of convenient cleaning for herders. The University of Hoffenheim in Germany has developed a solar refrigeration system that uses a solar refrigerator to make ice cubes, which are then used in milk buckets to maintain the quality of the milk for 3-16 hours. The designs of the above two milk buckets are aimed at helping people in economically underdeveloped areas improve the safety and hygiene of raw milk collection and transportation.

The following description of exemplary embodiments of the present invention is made in conjunction with the accompanying drawings, in which various details of the embodiments of the present invention are included to facilitate understanding. These details should be considered as merely exemplary. Therefore, it should be appreciated by those skilled in the art that various changes and modifications may be made to the embodiments described herein without departing from the scope and spirit of the present invention. Similarly, for the sake of clarity and conciseness, descriptions of well-known functions and structures are omitted in the following description.

### Device

### 1. Temperature Control and Insulation Device

The non-energy-dependent temperature control and heat preservation device according to the present invention may include a temperature control portion and a gas storage portion. The temperature control portion includes an inner interlayer, an outer interlayer surrounding the inner interlayer, and a receiving cavity defined by the inner interlayer. The inner interlayer is in communication with the gas storage portion.

### 1.1 Autonomous Cooling and Heat Preservation Device

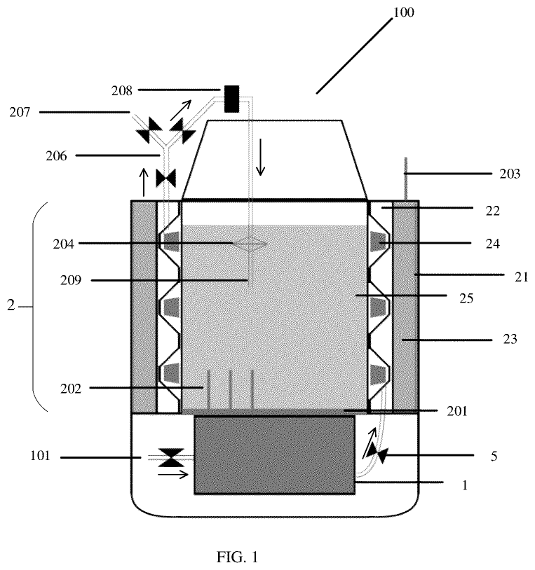

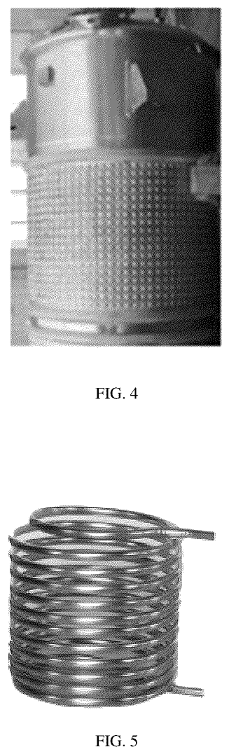

Specifically, referring to FIGS. 1 to 5, according to a first embodiment of the present invention, a temperature-regulating and heat-insulating device 100 includes a gas storage portion 1 for storing liquefied gas; a temperature-regulating portion 2 filled with a thermally conductive or heat-insulating material and detachably connected to the gas storage portion 1. Preferably, the temperature-regulating and heat-insulating device can be a portable, self-cooling and heat-insulating milk transport bucket.

### 1.1.1 Gas Storage

Gas storage section 1 is connected to an external gas source via a gas filling port 101 for filling with liquefied gas, or pre-solidified gas can be placed in gas storage section 1. The amount of liquefied or solidified gas contained in gas storage section 1 can be estimated based on the type and amount of the material to be cooled (i.e., the contents of temperature control section 2) and the pre-cooling temperature. The contents can be liquid, for example, raw milk (fresh cow's milk or fresh goat's milk, such as yak milk).

The gas storage unit may have a vibration-absorbing and/or explosion-proof design to prevent damage during transportation and use, thereby improving safety. Specifically, the vibration-absorbing design may employ physical shock absorption, such as wrapping the gas storage unit with foam or an inflatable membrane to absorb and cushion vibrations or impacts. The explosion-proof design may include an explosion-proof valve on the gas storage unit that automatically opens to reduce pressure when the pressure inside the gas storage unit reaches a threshold.

According to a specific embodiment, the liquefied gas and the solidified gas that can be used in the present invention can be independently selected from one or more of carbon dioxide, nitrogen, oxygen, air, butane, isobutane, propane and other inert gases, preferably carbon dioxide. The other inert gases can be selected from argon, neon and xenon.

The amount of stored liquefied gas is estimated based on the heat exchange required to achieve a predetermined temperature drop. According to one specific embodiment, the liquefied gas used may be carbon dioxide, and the contents may be milk. Because milk and water have similar densities, the required amount of liquefied gas (e.g., carbon dioxide) can be estimated using the properties of water.

The vaporization of 1 kg of liquid carbon dioxide absorbs approximately 580 kilojoules of heat, or about 138.5 kilocalories. A kilocalorie is released to lower the temperature of 1 liter of water by 1° C. 138.5 kilocalories can lower the temperature of 138.5 liters of water by 1° C., and thus, 25 kg of water by 5.52° C. Therefore, to cool 25 kg of water at 37° C. to 10° C., 4.89 kg of liquid carbon dioxide must be vaporized. To cool 25 kg of water at 37° C. to 4° C., 5.98 kg of liquid carbon dioxide must be vaporized. The temperature and mass of the contents can be measured using a thermometer and gravity sensor to determine the rate and amount of gas released.

The material of the gas storage part 1 can be a light material with a certain strength. For example, when the selected gas is carbon dioxide, the material of the storage part 1 can be aluminum alloy, steel or carbon fiber.

According to a specific embodiment, when the selected gas is carbon dioxide, an aluminum alloy gas cylinder can be used, such as a 4-liter gas cylinder with a diameter of 14 cm, a height of 53 cm, a weight of 6 kg, and a filling volume of 2.4 kg of carbon dioxide.

According to another specific embodiment, when the selected gas is carbon dioxide, a steel cylinder can be used and filled in accordance with national standards, such as GB14193-2009. For example, the calculation can be as follows.

The filling factor for carbon dioxide is generally 0.6. Therefore, according to specifications, a 40 L cylinder can hold a maximum of 40 kg×0.6 kg=24 kg of carbon dioxide. Therefore, a full cylinder can release 24/44×22.4 kg=12.2 m³ of gas. 6 kg of liquid carbon dioxide requires a 10 L cylinder: 6/0.6=10. The total volume of carbon dioxide gas that a 10 L cylinder can hold is 12.2/4 kg=3.05 m³.

### 1.1.2 Temperature Regulation Part

The temperature regulation portion 2 may include an inner interlayer 22 and an outer interlayer 21 surrounding the inner interlayer 22. Further, the inner interlayer 22 defines a receiving cavity for receiving an object to be cooled, i.e., contents.

As Shown in FIG. 1, the temperature regulation portion comprises a main body portion and a tapered portion with a gradually decreasing cross-sectional size, and the inner and outer interlayer structures may be provided only in the main body portion.

### 1.1.2.1 Inner Layer

According to a specific embodiment, as shown in FIG. 1, the inner interlayer 22 has a hollow structure and can be connected to the gas storage part 1. Specifically, it can be connected through a pipeline to transport the liquefied or solidified gas contained in the gas storage part 1 to the hollow structure 24 of the inner interlayer 22, thereby utilizing the process of vaporization of the liquefied gas or sublimation of the solidified gas to cool the contents.

The inner tube of the inner interlayer 22 defines a receiving cavity. The inner tube can be made of stainless steel with good thermal conductivity, or a food-grade plastic material, such as polyethylene, polypropylene or polycarbonate.

The hollow structure of the inner interlayer 22 may have an exhaust port 206, allowing liquefied gas to be continuously injected and vaporized, thereby achieving cooling. This exhaust port 206 can be connected to one or more pipelines. For example, a branch pipeline 207 can be connected to one or more of the following: a filter assembly, a muffler, a centrifugal assembly, and a gas recovery and adsorption device. Another branch pipeline can be connected to the holding chamber, for example, after being filtered by a bacterial filter 208. Preferably, the outlet 209 of this branch pipeline is located below the surface of the contents and is provided with a check valve 204 to prevent backflow.

According to another embodiment, the inner interlayer 22 may have a jacket structure, such as a pillow-plate jacketed structure. The pillow-plate jacketed structure is an improvement over conventional jacket structures. It utilizes a uniformly distributed honeycomb structure between the inner tube and the jacket, enhancing the bearing capacity of both.

The function of the pillow-plate jacketed structure is to increase the flow velocity of the fluid in the jacket cavity under the condition that the medium supply conditions remain unchanged. At the same time, the fluid will collide with the honeycomb points many times, thereby forming local small eddies, making the medium flow in the cavity turbulent, accelerating the heat exchange speed and improving the heat exchange efficiency. Furthermore, the pillow-plate jacketed structure is integrated with the inner tube (for example, by welding), effectively increasing the load-bearing capacity of both the inner tube and the jacket.

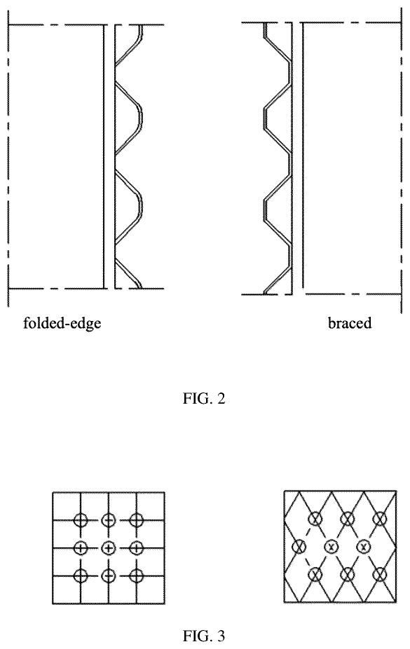

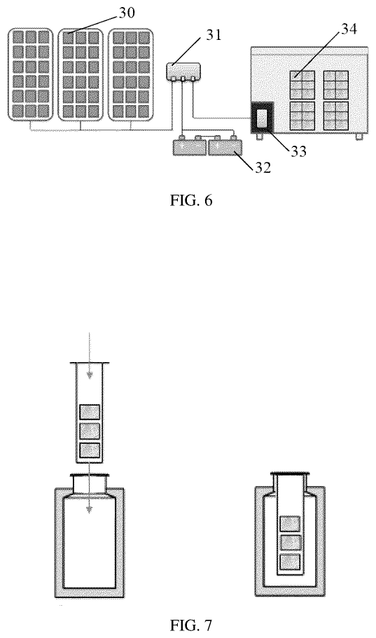

As shown in FIGS. 2 to 4, pillow-plate jacketed structure can generally be categorized as either folded-edge or braced. The folded-edge type typically involves folding the jacket inward, fitting it to the cylinder, and then welding it. Braced-edge types use small, stamped cones or steel pipes as bracing elements. The weld points of the pillow-plate jacketed structure can be arranged in various configurations on the cylinder, such as an equilateral triangle or square, and in concentric circles on the head. As shown in FIG. 5, the hollow structure of the inner interlayer allows for heat exchange using coils.

When the inner interlayer 22 adopts a pillow-plate jacketed structure, the gas storage part 1 can be connected to the sleeve of the pillow-plate jacketed structure through a pipeline.

Based on the above analysis, the gas storage portion 1 and the temperature control portion 2 are detachably connected to facilitate maintenance or replacement. The location of this connection can be adjusted according to actual needs. For example, the gas storage portion 1 can be connected to the lower end of the temperature control portion 2 or to any side. Specifically, the two contact surfaces of the connection portion have matching shapes.

According to another specific embodiment, the exhaust port of the hollow structure of the inner interlayer can be connected to the contents 25 of the receiving cavity through a pipe, so that the gas after heat exchange is filled into the contents in the receiving cavity to adjust the acidity and temperature of the contents. The liquefied or solidified gas can be one or more of carbon dioxide, nitrogen, oxygen, air, butane, isobutane, propane and other inert gases. Preferably, the gas can be carbon dioxide. According to a specific embodiment, when the gas filled is carbon dioxide and the contents are raw milk, the carbon dioxide filled into the raw milk can adjust the acidity and temperature of the raw milk. For example, the pH value of the contents can be adjusted to 6.0-6.2, preferably 6.1; the temperature of the contents can be adjusted to 4-20° C., for example 4-10° C., preferably 4-6° C.

Specifically, the flow rate of gas filling can be adjusted as needed, and the adjustment method can be adopted by setting valves at necessary positions of the pipeline. For example, valves can be set respectively on the main pipeline and each branch pipeline. For example, as shown in FIG. 1, a valve 5 is provided on the exhaust pipeline of the gas storage part 1, and valves can be set respectively on the main pipeline and branch pipeline connected to the exhaust port of the hollow structure of the inner interlayer to control whether the gas is input. At the same time, specific valves can also be set to control the timing of gas delivery and the gas delivery amount (flow rate) as needed.

According to a specific embodiment, one or more of a temperature testing element, a pH testing element, an antibiotic content testing element, a microbial content testing element, a milk-specific protein testing element and a gravity sensor can be set in the receiving cavity. Preferably, one or two of a gravity sensor, a temperature testing element (for example, a thermometer or a temperature sensor) and a pH testing element can be set.

The gravity sensor can control the vaporization rate of liquid gas or the sublimation rate of solidified gas according to the weight of the contents, so as to optimize the cooling efficiency.

When the temperature sensor measures the contents below a set lower limit (e.g., 4° C.), the valve (e.g., the valve on the main pipe or the valve on the branch pipe) is closed, stopping the flow of gas into the inner hollow structure. When the temperature sensor measures the contents above a set upper limit (e.g., 20° C.), the valve is opened to start the flow of gas into the inner hollow structure. Gas can be supplied all at once until the contents' temperature drops below the set upper limit, or it can be supplied gradually.

When the pH value of the contents measured by the pH testing element is below a set lower pH limit (e.g., a pH value below 6.0 for raw milk), the valve (e.g., the valve of the main pipe or the valve of the second branch pipe) can be closed, stopping the supply of gas to the holding chamber. When the pH value of the contents measured by the pH testing element is above a set upper pH limit (e.g., a pH value above 6.2 for raw milk), the valve can be opened to start supplying gas to the holding chamber. The gas can be supplied all at once until the pH value of the contents drops below the set upper pH limit, or it can be supplied gradually. For example, when the dissolved gas in the contents gradually evaporates during transportation and the concentration decreases, the gas lost by evaporation can be gradually replenished.

### 1.1.2.2 External Interlayer

According to one specific embodiment, as shown in FIG. 1, an outer interlayer 21 is disposed around an inner interlayer 22. Specifically, the outer interlayer 21 may be filled with a thermal insulation material or a heat-conducting material 23. The thermal insulation material may be a lightweight, thermally insulating material, such as a foam. The foam may be one or more of polyurethane foam, polystyrene foam, and polyester foam.

The outer interlayer 21 may also be filled with a heat-conducting material, such as a metal sheet. For example, when the ambient temperature is low (e.g., below 4° C.), the outer interlayer may be filled with a heat-conducting metal sheet to quickly dissipate the heat of the contents to the environment, thereby effectively utilizing the ambient conditions to cool the contents.

Furthermore, when a temperature testing element or a pH testing element is provided in the receiving cavity, an observation window may be provided in the outer interlayer 21, or a display screen may be provided on the outer surface of the outer interlayer 21 for observing or displaying the temperature and/or pH value.

The inner cylinder of the temperature regulation part 2 can be made of stainless steel or food grade plastics, such as polyethylene, polypropylene, or polycarbonate. The outer interlayer can also be provided detachably, such as a fiber cloth cladding filled with foam material, detachably surrounding the inner interlayer periphery.

The outer layer is typically protected by a housing, preferably with a crash-resistant design. According to one embodiment, the outer housing is preferably made of a thermally insulating and lightweight material, such as polyethylene, polypropylene, or polycarbonate. The housing may also include an opening and closing mechanism to connect to the gas storage unit and facilitate replacement and maintenance of the gas storage unit.

### 1.1.3 Auxiliary Temperature Control Components

The autonomous cooling and heat preservation device of the present invention may also include an auxiliary temperature regulation component. This auxiliary temperature regulation component may be detachably connected to the temperature regulation portion, for example, and may be used interchangeably with the gas storage portion as an alternative temperature regulation device, or may be used simultaneously with the gas storage portion.

### 1.1.3.1 Solar Refrigeration Components

According to another specific embodiment of the present invention, the auxiliary temperature regulation component may be a solar cooling component.

Referring to FIG. 6, the solar cooling component may include a refrigerator 23, solar panels 20, a control panel 21, a battery 22, and an ice storage assembly 24. Specifically, the solar panels are equipped with a solar cell array that converts solar radiation into electrical energy. The control panel is electrically connected to the solar panels and the battery, controlling the overall operation of the solar cooling component and protecting the battery from overcharge and overdischarge. The control panel controls the supply of electrical energy to the refrigerator for cooling, such as ice making. Alternatively, during periods of sufficient sunlight, the electrical energy generated by the solar panels can be transferred to the battery for storage and then used to power the refrigerator during periods of insufficient sunlight. The battery used in the present invention may be a lithium battery, nickel-metal hydride battery, or nickel-cadmium battery. When powered, the refrigerator freezes water to form ice cubes. As shown in FIG. 7, the resulting ice cubes can be placed in the ice storage assembly, which may have a sealable partition structure and be placed within the chamber of a temperature control and insulation device to lower the temperature of the contents within.

According to a specific embodiment, the refrigerator, solar panel, control panel and battery can be components provided independently of the temperature regulation and heat preservation device.

The amount of ice added can be adjusted based on the volume of the chamber's contents, the ambient temperature, and the set pre-cooling temperature. The heat of melting of ice is 3.36×10⁵ J/kg. The specific heat capacity of water is 4200 J/(kg·K), where Q=heat of melting of ice×m, where m is mass and Q is the amount of heat absorbed. Assuming the temperature is 0° C. before and after melting, only the heat absorbed by melting is calculated. When the contents are milk, since milk and water have similar densities, the performance parameters of water can be used to estimate the amount of ice required.

Specifically, a 1° C. drop in the temperature of 1 liter of water requires the release of 1 kcal of heat. To cool 25 kg of 37° C. water to 10° C., 675 kcal of heat are required. The melting of 1 kg of ice absorbs approximately 336 kJ of heat, or about 80.2 kcal. The temperature of the melted water can be considered 0° C., and the heat absorbed by the 1 kg of water rising to 10° C. is about 10 kcal. This means that 1 kg of ice absorbs approximately 90.2 kcal of heat when it melts and rises to 10° C. Therefore, to cool 25 kg of 37° C. water to 10° C., 7.48 kg of ice are required to melt. Given the volume occupied by ice in the storage chamber, the cooling effect of ice is typically only an auxiliary cooling method. Placing an ice tray filled with ice in the center of the storage chamber helps quickly and effectively reduce the temperature at the center of the contents, complementing heat transfer cooling methods such as using a medium (vaporization of liquefied gas or sublimation of solidified gas) within the inner interlayer.

### 1.1.3.2 Semiconductor Cooling Devices

A semiconductor cooling device is a heat pump that utilizes the Peltier effect of semiconductor materials. When direct current passes through a galvanic couple composed of two different semiconductor materials connected in series, heat is absorbed and released at either end of the galvanic couple, achieving cooling. This cooling technology generates negative thermal resistance and features no moving parts, resulting in high reliability.

### 1.1.3.3 Self-Heating Components

According to a specific embodiment of the present invention, the auxiliary temperature control component may be a self-heating component. The self-heating component includes a self-heating material package. The self-heating material package may include at least a first component and a second component. The first component can react exothermically with water and may be, for example, one or more of quicklime, aluminum powder, and iron powder. The reaction of these components with water generates heat, causing the water temperature to rise rapidly until water vapor is generated. Specifically, the reaction equation is as follows:

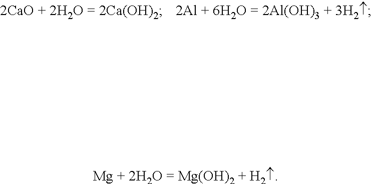

The second component can be one or more of diatomaceous earth, coke, and activated carbon. They have a porous structure, which is conducive to the attachment of other components and facilitates full contact between components and chemical reactions.

Furthermore, the self-heating material package can also include one or more of sodium carbonate, calcium chloride, ferric sulfate, sodium bicarbonate and sodium chloride, which are used to absorb the infiltrated trace moisture, prevent the calcium oxide from absorbing water and gradually becoming ineffective, and at the same time play an auxiliary role in the chemical reaction.

The self-heating material package with the above-mentioned ingredients operates as follows: the quicklime in the first component first reacts with water, releasing heat, heating the water to above 150° C. The steam temperature can reach 200° C., which can be transported to the inner interlayer of the temperature regulation portion 2 to heat the contents. The iron and aluminum powders in the first component then react with oxygen, releasing a small amount of heat. They then form a “galvanic cell” effect with the activated carbon, water, and salt, further releasing heat through redox reactions.

According to a specific embodiment, the reaction occurring in the self-heating component includes the following two stages:

### (Stage One)

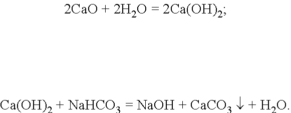

### (Stage Two)

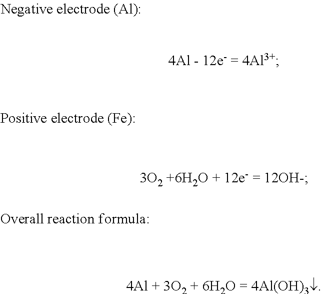

The self-heating component can be used to continuously heat the contents and adjust their temperature autonomously.

### 1.1.4 Signal Processing Components

According to a specific embodiment, the temperature regulation and heat preservation device of the present invention may further include a signal processing component. The signal processing component receives the signal transmitted from the temperature regulation and heat preservation device, compares the received signal value with the set threshold value, and controls the temperature regulation measures according to the comparison result. The signal processing component can be arranged on the outer surface of the outer interlayer or the inner interlayer of the temperature regulation part, and communicates with the test elements such as the temperature test element and/or pH test element arranged in the receiving cavity. Preferably, one or more 202 of the temperature test element, pH test element, antibiotic content test element, microbial content test element, and milk-specific protein test element can be arranged in the receiving cavity, a gravity sensor 201 can be arranged at the bottom, and a positioning sensor (such as a GPS or Beidou positioning sensor) can be arranged at the top.

The above-mentioned test elements can monitor parameters such as the temperature, pH value, antibiotic content, microbial content, milk-specific protein, geographical location and content volume of the contents in the receiving chamber in real time, and these test elements can be connected to the valve 5 of the exhaust port of the gas storage part to control the gas flow rate according to the monitoring results.

Specifically, when the temperature control and heat preservation device includes a temperature testing element and/or a pH testing element, the temperature testing element and/or the pH testing element transmits the tested temperature and/or pH value of the contents to the signal processing component. The signal processing component compares the received temperature and/or pH value with the corresponding set maximum temperature and minimum temperature, and/or the maximum pH value and the minimum pH value. If the test temperature is higher than the maximum set temperature, liquefied gas is input into the inner interlayer, or an ice tray containing ice cubes is placed in the containing chamber; if the test temperature is lower than the minimum set temperature, the input of liquefied gas into the inner interlayer is stopped. If the test pH value is higher than the maximum set value, carbon dioxide gas is input into the containing chamber; if the test pH value is lower than the minimum set value, the input of carbon dioxide gas into the containing chamber is stopped.

According to a specific embodiment, the temperature control and heat preservation device of the present invention may further include a positioning device and an alarm generating device. The positioning device and the alarm generating device may be mounted on the cow. The signal processing component may receive a positioning signal from the positioning device and compare the received positioning signal with a preset positioning range. If the position of the positioning signal exceeds the preset positioning range, the alarm generating device may be controlled to sound an alarm, prompting the cow to return to the breeding ground.

In summary, the temperature regulation and heat preservation device according to the present invention can cool or heat the contents autonomously, which is beneficial to the collection and transportation of raw milk in areas with inconvenient transportation. It is particularly suitable for use by dispersed livestock farmers and has the characteristics of portability, simple and effective temperature control.

### 1.2 Autonomous Cooling and Fresh-Keeping Device

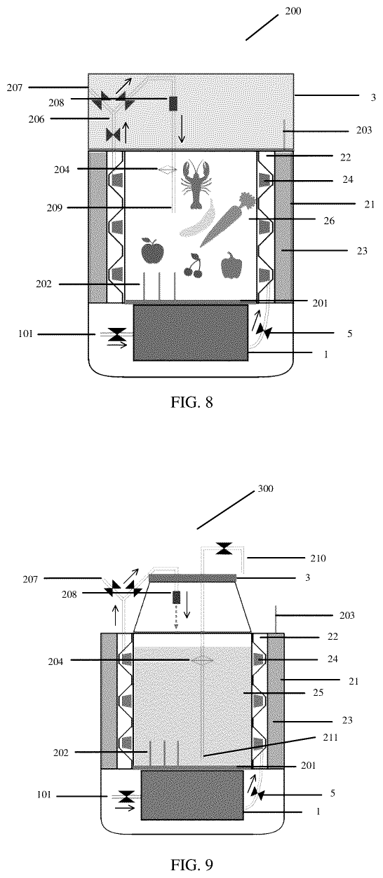

Referring to FIG. 8, a temperature-regulating and heat-insulating device 200 according to a second embodiment of the present invention includes a gas storage portion 1 for storing liquefied gas; a temperature-regulating portion 2 filled with a thermally conductive or heat-insulating material and removably connected to the gas storage portion 1; and a lid assembly 3 for cooperating with the temperature-regulating portion 2 to form a sealed structure. Preferably, the temperature-regulating and heat-insulating device can be a portable, autonomous cooling and fresh-keeping device.

### 1.2.1 Gas Storage

Gas storage section 1 is connected to an external gas source via a gas filling port 101 for filling with liquefied gas, or pre-solidified gas. The amount of liquefied or solidified gas contained in gas storage section 1 can be estimated based on the type and amount of the item to be cooled (i.e., the contents of temperature control section 2) and the pre-cooling temperature. The contents can be solid, such as fresh produce, mushrooms, fruits, and vegetables that require low-temperature preservation.

The gas storage portion may have a vibration buffering protection design and/or an explosion-proof design to prevent damage to the gas storage portion during transportation and use and improve safety. The vibration buffering protection design and/or explosion-proof design are as described above for the autonomous cooling and heat preservation device.

According to a specific embodiment, the gas that can be used for liquefaction or solidification of the present invention can be selected from one or more of carbon dioxide, nitrogen, oxygen, air, butane, isobutane, propane and other inert gases, preferably carbon dioxide. The other inert gases can be selected from argon, neon and xenon etc.

The material of the gas storage part 1 can be a light material with a certain strength. For example, when the selected gas is carbon dioxide, the material of the storage part 1 can be aluminum alloy, steel or carbon fiber.

### 1.2.2 Temperature Regulation Part

As shown in FIG. 8, the temperature regulation portion 2 may include an inner interlayer 22 and an outer interlayer 21 surrounding the inner interlayer 22. Further, the inner interlayer 22 defines a receiving cavity for receiving an object to be cooled, i.e., contents.

### 1.2.2.1 Inner Layer

According to a specific embodiment, as shown in FIG. 8, the inner interlayer 22 has a hollow structure and can be connected to the gas storage part 1. Specifically, it can be connected through a pipeline to transport the liquefied or solidified gas contained in the gas storage part 1 to the hollow structure 24 of the inner interlayer 22, thereby utilizing the process of vaporization of the liquefied gas or sublimation of the solidified gas to cool the contents.

The inner tube of the inner interlayer 22 defines a receiving cavity. The inner tube can be made of stainless steel with good thermal conductivity, or a food-grade plastic material, such as polyethylene, polypropylene or polycarbonate.

The hollow structure of the inner interlayer 22 may have an exhaust port 206, allowing liquefied gas to be continuously injected and vaporized, thereby achieving cooling. This exhaust port 206 can be connected to one or more pipelines. For example, a branch pipeline 207 can be connected to one or more of the filter assembly, silencer, centrifugal assembly, and gas recovery and adsorption device. Another branch pipeline can be connected to the receiving chamber, for example, after being filtered by the bacterial filter device 208. Preferably, the outlet 209 of this branch pipeline is located within the receiving chamber, and a check valve 204 is provided to prevent backflow.

The gas filled into the containment chamber creates a controlled atmosphere for freshness preservation. To effectively extend the shelf life and freshness of the contents (e.g., fresh produce, fruits, and vegetables), the gas typically selected is one or more of carbon dioxide, nitrogen, argon, and oxygen. Carbon dioxide is a gaseous antibacterial agent that can prolong the stagnation or latent period of microbial growth and reproduction, slowing their logarithmic growth. Carbon dioxide readily dissolves in the water in food, producing carbonic acid, which lowers the pH of the food, thereby facilitating food preservation. Nitrogen is an inert gas and does not chemically react with food. As a filling gas, it can reduce the oxidation rate of fats, aromatics, and pigments in food. Argon has significant antibacterial properties and can replace nitrogen as the filling gas in mixed gases. It also inhibits oxidation reactions in food and slows metabolism. The presence of oxygen prevents the growth of anaerobic pathogens such as Clostridium. Low oxygen levels reduce the respiration rate of fresh fruits and vegetables while maintaining the aerobic respiration and metabolism necessary for their freshness.

According to one specific embodiment, the controlled atmosphere (CA) gas may include 0-80% oxygen, 0-100% carbon dioxide, and 0-50% nitrogen. For example, when the contents are fresh meat products, the carbon dioxide concentration in the CA gas should not be too high, otherwise it will be detrimental to the formation of oxymyoglobin. For example, it may be 70%-75% oxygen, 25%-30% nitrogen, or 60%-70% carbon dioxide, 15%-40% nitrogen. If the contents are fresh fruits and vegetables, the CA gas may include a concentration of 2%-6% oxygen, 5%-10% carbon dioxide, and the balance nitrogen. If the contents are cooked or baked goods, the CA gas may include a concentration of 60%-80% carbon dioxide and 20%-40% nitrogen.

The hollow structure of the inner interlayer is as described above for the autonomous cooling and heat preservation device.

### 1.2.2.2 External Interlayer

According to one specific embodiment, as shown in FIG. 8, an outer interlayer 21 is disposed around an inner interlayer 22. Specifically, the outer interlayer 21 may be filled with a thermal insulation material 23. The thermal insulation material may be a lightweight, thermally insulating material, such as a foam material. The foam material may be one or more of polyurethane foam, polystyrene foam, and polyester foam.

### 1.2.3 Cover Assembly

According to a specific embodiment, as shown in FIG. 8, the cover assembly 3 used in the present invention may have a shape matching the temperature regulation portion 2 and may be firmly connected to the temperature regulation portion 2, preferably forming a sealed connection.

According to a specific embodiment, the inner surface of the cover assembly may have a threaded structure that matches the temperature regulation part 2, for example, the cover assembly 3 has an internal thread, and the top outer side of the temperature regulation part 2 has an external thread, and the two match, or the cover assembly 3 may be provided with a locking structure (such as a lock) so that the cover assembly 3 and the temperature regulation part 2 can form a stable sealing connection.

The autonomous cooling and fresh-keeping device may further include an inner interlayer jacket structure, an outer interlayer, an auxiliary temperature regulation component and a signal processing component, which are as described above for the autonomous cooling and fresh-keeping device.

The autonomous cooling and preservation device according to the present invention utilizes liquefied gas vaporization or solidified gas sublimation for cooling, rather than relying on energy. It also utilizes the controlled atmosphere created by the vaporization or sublimation of liquefied gas to preserve the contents of fresh fruits and vegetables, effectively extending the shelf life of wild delicacies or marine catches during refrigerated transportation. In addition to cooling, carbon dioxide or other inert gases can also remove oxygen from the insulated container (controlled atmosphere preservation technology), providing antioxidant, color-protecting, and freshness-preserving benefits. The gas is recyclable and can be transported at room temperature.

### 1.3 Portable Beverage Refrigeration and Aeration Device

Referring to FIG. 9, a temperature-regulating and heat-insulating device 300 according to a third embodiment of the present invention includes a gas storage portion 1 for storing liquefied gas; a temperature-regulating portion 2 filled with a thermally conductive or heat-insulating material and removably connected to the gas storage portion 1; and a lid assembly 3 for mating with the temperature-regulating portion 2 to form a sealed structure. Preferably, the temperature-regulating and heat-insulating device can be a portable beverage cooling and aeration device.

### 1.3.1 Gas Storage

Gas storage portion 1 is connected to an external gas source via gas filling port 101 for filling with liquefied gas, or pre-solidified gas. The amount of liquefied gas or solidified gas contained in gas storage portion 1 can be estimated based on the type and amount of the object to be cooled (i.e., the contents of temperature control portion 2) and the pre-cooling temperature. This content can be a liquid beverage, such as beer or cola.

The gas storage portion may have a vibration buffering protection design and/or an explosion-proof design to prevent damage to the gas storage portion during transportation and use and improve safety. The vibration buffering protection design and/or explosion-proof design are as described above for the autonomous cooling and heat preservation device.

According to a specific embodiment, the gas that can be used for liquefaction of the present invention or the gas that solidifies can be selected from one or more of carbon dioxide, nitrogen, oxygen, air, butane, isobutane, propane and other inert gases, preferably carbon dioxide. The other inert gases can be selected from argon, neon and xenon etc.

The material of the gas storage part 1 can be a light material with a certain strength. For example, when the selected gas is carbon dioxide, the material of the storage part 1 can be aluminum alloy, steel or carbon fiber.

### 1.3.2 Temperature Regulation Part

As shown in FIG. 9, the temperature regulation portion 2 may include an inner interlayer 22 and an outer interlayer 21 surrounding the inner interlayer 22. Further, the inner interlayer 22 defines a receiving cavity for receiving an object to be cooled, i.e., contents.

The temperature regulation part comprises a main body part and a tapered part with a gradually smaller cross-sectional size, and the inner interlayer and outer interlayer structures can be arranged only on the main body part.

### 1.3.2.1 Inner Layer

According to a specific embodiment, as shown in FIG. 9, the inner interlayer 22 has a hollow structure and can be connected to the gas storage part 1. Specifically, it can be connected through a pipeline to transport the liquefied gas contained in the gas storage part 1 to the hollow structure 24 of the inner interlayer 22, thereby utilizing the process of vaporization of the liquefied gas to cool the contents 25.

The inner tube of the inner interlayer 22 defines a receiving cavity. The inner tube can be made of stainless steel with good thermal conductivity, or food-grade plastic material, such as polyethylene, polypropylene or polycarbonate, preferably stainless steel.

The hollow structure of the inner interlayer 22 may have a vent or an exhaust port, allowing for the continuous injection and vaporization of liquefied gas, thereby achieving cooling. This vent can be connected to one or more pipelines. For example, a branch pipeline 207 can be connected to one or more of the filter assembly, muffler, centrifugal assembly, and gas recovery and adsorption device. Another branch pipeline can be connected to the upper portion of the receiving chamber, for example, after being filtered by the bacterial filter 208 and then passed into the receiving chamber. Preferably, the outlet of this branch pipeline is located above the surface of the contents in the receiving chamber. The injected gas is preferably carbon dioxide, which imparts a bubbly texture to the liquid beverage and enhances foam formation.

Furthermore, a liquid outlet pipe is provided in the temperature regulation part, the liquid inlet 211 of which is located at the bottom of the receiving chamber, and a check valve 204 is provided to prevent backflow, and a valve is provided to control the content 25 to flow out from the liquid outlet 210.

The portable beverage preparation device may further include an inner sandwich jacket structure, an outer sandwich, an auxiliary temperature regulation component and a signal processing component, which are as described above for the autonomous temperature reduction and heat preservation device.

The portable beverage refrigeration and aeration device according to the present invention can conveniently utilize the vaporization of liquefied gas or the sublimation of solidified gas to cool down the beverage without electric refrigeration, and fill the beverage with gas to give the beverage a bubbly taste. If stainless steel is used, the beverage can cool down by itself, and the gas injected into the receiving chamber generates air pressure to prompt the beverage to be pumped out, while increasing foam formation.

### 2. Filtration Device

In the above description of the inner interlayer hollow structure of the temperature regulation and heat preservation device, it is mentioned that the exhaust port of the hollow structure can be connected to the filter device through the branch pipe 207. The filter device of the present invention may include a negative pressure filter device and a positive pressure filter device.

### 2.1 Negative Pressure Filtration Device

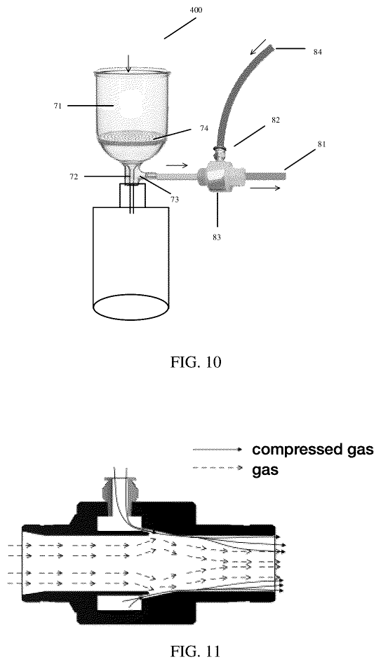

As shown in FIG. 10, the negative pressure filtration device 400 may include a funnel, a container body, and a vacuum generator 83.

Specifically, the funnel may include a cover 71 and a body 72. A filter material 74, such as filter paper, is disposed below the cover 72. The body 72 has a branch 73 for connecting to a vacuum generator 83. The air inlet 82 of the vacuum generator 83 can be connected to an independent air source, such as the air storage portion of a temperature control and insulation device via a pipe 84, or to the exhaust port of an inner interlayer via a pipe 84. The other end (outlet end) 81 can be connected to a muffler or a gas adsorption recovery device, or can be directly vented.

Referring to FIG. 11, this filtration device uses compressed gas as the power source and utilizes the ejection effect of a high-speed airflow (e.g., a gas flow rate of 0.5 to 0.7 cubic meters per minute, which can create a vacuum pressure of 38 to 62 kPa) to create a partial vacuum. This draws the gas on the left side of the vacuum generator and ejects it to the right. The interior is equivalent to a straight pipe, allowing materials of appropriate size to pass through.

### 2.2 Positive Pressure Filtration Device

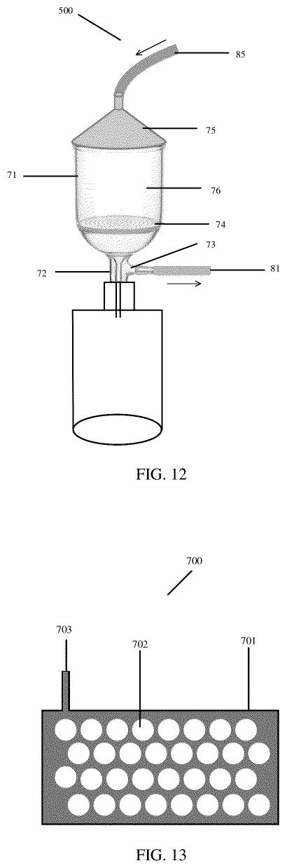

As shown in FIG. 12, the positive pressure filtration device 500 may include a sealing cover 75, a funnel 76 and a container body.

Specifically, funnel 76 may include a cover 71 and a body 72. A filter material 74, such as filter paper, is disposed below cover 72, and body 72 has branches 73. The funnel's air inlet 85 can be connected to an independent air source, such as the air storage portion of a temperature control and insulation device, or to the exhaust port of an inner interlayer. The other end (outlet end 81) can be connected to a muffler or gas adsorption recovery device, or can be directly vented.

The exhaust port in the inner interlayer can be connected to the sealing cap at the top of the filter assembly. The upper portion of the filter assembly is a sealed container. The liquid to be filtered is sealed in the upper portion. The bottom of the liquid to be filtered comes into direct contact with the filter material (such as a filter screen, filter cloth, or filter paper). The gas in the inner interlayer is injected into the filter through the sealing cap at the top of the filter assembly, increasing pressure to help the liquid pass through the filter screen, cloth, or paper.

### 3. Gas Recovery Adsorption Device

In the present invention, the vaporized gas, after undergoing heat exchange in the hollow structure of the inner interlayer to cool the contents, can be passed into the containing cavity to adjust the acidity of the contents or adjust the gas composition, and can also be passed into the gas adsorption recovery device to recover the used gas for reuse.

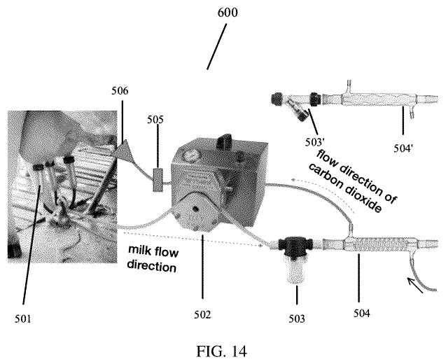

As shown in FIG. 13, a gas adsorption recovery device 700 of the present invention may include a gas adsorption tank 701, a gas adsorbent placed in the gas adsorption tank, and a gas injection port 703 is provided on the gas adsorption tank 701.

According to a specific embodiment, the recovered gas is carbon dioxide, and the corresponding gas adsorbent used can be one or both of calcium hydroxide and sodium hydroxide. For example, the adsorption reaction of carbon dioxide is as follows:

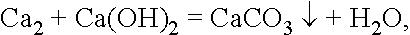

If there is excess carbon dioxide, the reaction will continue:

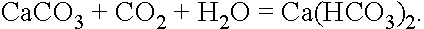

Through the adsorption reaction between the gas adsorbent and the gas, the gas can be completely recovered, stored in the gas bag and reused.

### 4. Gas-Driven Centrifugal Device

In the present invention, the vaporized gas, after undergoing heat exchange in the hollow structure of the inner interlayer to cool the contents, can be directed to the centrifuge assembly in addition to being passed into the containing cavity to adjust the acidity of the contents or the gas conditioning composition.

The exhaust port on the inner interlayer can be connected to a centrifuge. Gas from the inner interlayer is injected into the centrifuge assembly at a high speed (e.g., 1-5 cubic meters per minute), driving the centrifuge to rotate, thereby separating high-density impurities in the liquid from low-density components such as oil and fat. The centrifuge assembly can perform centrifugal separation in either a continuous or discontinuous manner.

### 5. Milk Collection and Temperature Control Device

The present invention provides a milk collecting and temperature regulation device, comprising a milking unit, a filtering unit and a heat exchange unit.

The milking unit comprises a power pump and one or more suction heads connected to the power pump. Preferably, the power pump can be a gas-driven peristaltic pump, an electrically driven peristaltic pump, or a gas- and electrically driven peristaltic pump, or a vacuum pump connected to a pulse generator.

Specifically, referring to FIG. 14, in a milk collection and temperature regulation device 600 according to one embodiment of the present invention, a milking unit may include one or more milking suction heads 501, a gas-driven peristaltic pump 502, a filtering unit 503, a heat exchange unit 504, and a cleaning unit (one or more gas nozzles) 506. A muffler 505 may also be included before the cleaning unit 506.

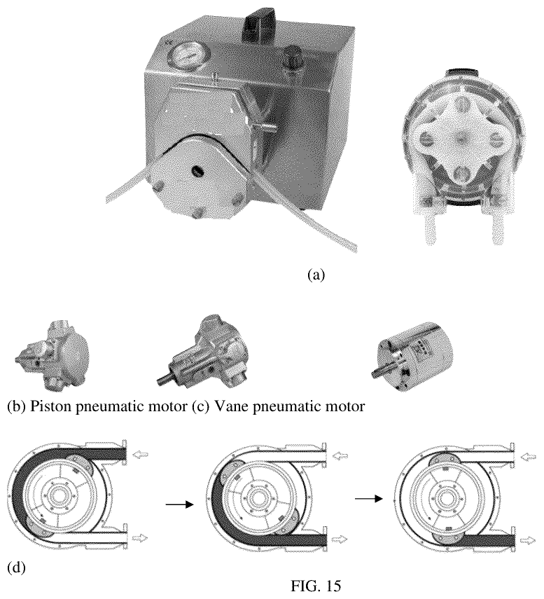

Referring to FIG. 15, (a)-(c) illustrate that a peristaltic pump can be driven by either a piston-type or vane-type pneumatic motor, with (b) schematically illustrating a piston-type pneumatic motor, (c) schematically illustrating a vane-type pneumatic motor, and (d) schematically illustrating the operating principle of a peristaltic pump. Stage 1: The pump hose is sequentially compressed by two pressure shoes mounted on a rotating wheel. The first pressure shoe creates a vacuum by squeezing the hose wall and draws the pumped liquid into the hose. Stage 2: The pumped liquid enters the hose, and the second pressure shoe compresses the hose and pushes the liquid toward the pump outlet. Stage 3: When the pressure shoe on the push-out side separates from the hose, the other diametrically opposite pressure shoe is already compressed, thus preventing internal fluid reversal. Due to the rotation of the wheel, the pumped fluid is successfully drawn in and pushed out.

In FIG. 15, gas drives a peristaltic pump, and the milking head draws milk. The drawn raw milk is pumped through a hose to a filter 503, which can be a T-type filter or, alternatively, a Y-type filter 503′. The filtered raw milk enters a heat exchange unit 504, which comprises an outer tube and an inner tube. Depending on the shape of the inner tube, it can be a serpentine condenser or, alternatively, a spherical condenser 504′. Gas flows into the outer tube of the heat exchange unit 504, cooling the raw milk within. This gas can come from an independent source or from the exhaust gas from the inner interlayer of the temperature control and insulation device described above. The gas exhausted from the outer tube of the heat exchange unit 504 flows into the peristaltic pump, driving it to work. The gas discharged from the peristaltic pump is decompressed by a muffler 505 and then ejected through a nozzle 506, cleaning the area around the cow's udder, removing dirt, loose hair, grass, and rainwater, reducing impurities in the raw milk, and simultaneously massaging the udder.

Referring to FIG. 16, according to another embodiment of the present invention, a milk collection and temperature regulation device 601 includes a peristaltic pump 502 driven by both gas and batteries, and further includes an airflow generator 507. The air inlet of the airflow generator 507 is connected to the exhaust port of the heat exchange unit 504, which in turn is connected to the peristaltic pump 502. Furthermore, the airflow generator 507 is electrically connected to the peristaltic pump 502 to provide power to the peristaltic pump 502.

The gas used in the above heat exchange unit can be selected from one or more of carbon dioxide, nitrogen, oxygen, air, butane, isobutane, propane and other inert gases, preferably carbon dioxide.

The milk collection and temperature regulation device of the present invention adopts an independent modular design and can be assembled according to needs. It uses a gas-driven peristaltic pump, an electric-driven peristaltic pump, a gas- and electric-driven peristaltic pump, or a vacuum pump connected to a pulse generator, an easily replaceable filter, and a heat exchange unit that utilizes gas heat exchange. It is easy to use and can simultaneously achieve milking, filtering, and cooling functions. The device is also easy to clean and transport, making it suitable for small-scale, decentralized farming.

### 6. Portable Milk Temperature Control Device

The invention provides a mobile milking and temperature regulation device which is convenient for cows to carry on their backs. The mobile milking and temperature regulation device comprises a power generation module, a temperature regulation and heat preservation device, a milking module and a sensor module.

The power generation module may include a power generation unit and an energy storage unit, the temperature control and heat preservation device is as described above, and the milking module includes a milking unit, a filtering unit, and a motor. The power generation unit is electrically connected to the motor and to the auxiliary temperature control component of the temperature control and heat preservation device.

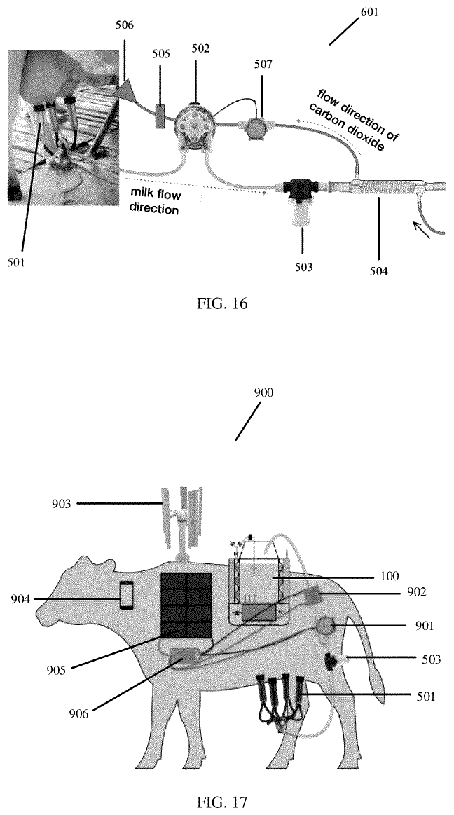

As shown in FIG. 17, the portable milk collection and temperature control device 900 according to one embodiment of the present invention includes a power generation module, a temperature control and heat preservation device, a milking module, and a sensor module. The power generation module may include a power generation unit and an energy storage unit, while the milking module may include a milking unit, a filter unit, and a motor.

Specifically, according to the flow direction of raw milk, the portable milk collection and temperature control device 900 includes, in sequence, a milking machine suction head 501, a filter 503 connected to the milking machine suction head 501, a motor 901 connected to the filter 503, a temperature control and insulation device 100, namely, an auxiliary temperature control component (such as an electrically driven semiconductor cooling device and/or a heat exchange component) 902 and a temperature control and insulation device body including a non-energy-dependent temperature control part and an air storage part, a power generation module electrically connected to the motor 901 and the auxiliary temperature control component 902, and a sensor module 904.

The auxiliary temperature regulation component may be a cold plate heat exchanger, with both sides of the cold plate tightly fitted to the semiconductor refrigeration device, so that the object to be cooled flows through the cold plate and is thereby cooled.

The structure of the temperature regulation and heat preservation device 100 is the same as that described above for the autonomous temperature reduction and heat preservation device.

The power generation unit may include one or both of a solar panel 905 and a wind turbine 903, and the energy storage unit may be an energy storage battery pack 906. The solar panel 905 and/or the wind turbine 903 generate electricity and charge the energy storage battery pack 906. The charged battery pack then supplies power to the auxiliary temperature control component 902 and the motor 901.

The above-mentioned sensor module 904 may include one or more of a positioning device and a cow health monitoring device, and be communicatively connected with the test element provided in the temperature control and insulation device 100, so that it can locate and monitor the health of the cow, monitor the milking status, and transmit indicators such as the temperature and pH value of the stored raw milk, so as to monitor the position and health of the cow, and one or more of the temperature, pH value, antibiotic content, microbial content and milk-specific protein of the raw milk.

The portable milk collection and temperature control device is composed of multiple independent modules, which is convenient for cows to carry and move. It integrates functions such as milking, filtering, cooling and remote monitoring, realizes the collection and cooling functions of raw milk in decentralized farming, and improves the utilization rate of raw milk.

### 7. Cleaning Device

The milking unit is easy to clean. The present invention provides a gas-driven cleaning device that can conveniently and promptly clean the pipelines of the milking unit.

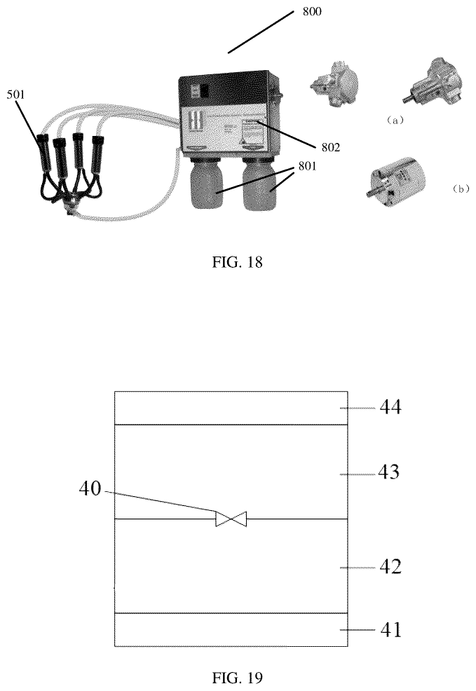

Specifically, referring to FIG. 18, a gas-driven cleaning device 800 according to one embodiment of the present invention may include a motor 802, a cleaning agent container 801 connected to the motor, and a milking machine 501 connected to the motor and cleaning agent container. The present invention may utilize a pneumatic motor, such as a piston-type pneumatic motor as shown in FIG. 18(a) or a vane-type pneumatic motor as shown in FIG. 18(b), preferably driven by carbon dioxide gas. This gas-driven cleaning device utilizes the gas-driven motor to circulate cleaning fluid through the milking machine pipeline for cleaning and disinfection.

### 8. Portable Beverage Preparation Device

As shown in FIG. 19, the present invention further provides a portable beverage preparation device, comprising a receiving portion for receiving beverage components, a tempering portion, and a cover 44.

The receiving portion includes a first portion 42 and an interlayer surrounding the first portion 42. The first portion 42 is detachably fixed to the gas storage portion 41. The second portion 43 is detachably fixed to the first portion 42 and is connected to the first portion 42 via a valve 40. The first portion 42 and the gas storage portion 41 may or may not be connected, and a valve may be provided to control the flow of gas as needed.

The first part contains a first liquid beverage component, and the second part contains a second liquid beverage component or a solid beverage component. The temperature regulation part can heat the containing part or cool the containing part to obtain a beverage at a desired temperature.

According to one embodiment, the temperature regulation portion 41 can contain liquefied gas or solidified gas, and can deliver the liquefied or solidified gas to the containing portion as needed to cool the containing portion. According to another embodiment, the temperature regulation portion 41 can include a self-heating material bag to increase the temperature of the containing portion.

The delivered liquefied gas includes a first gas delivered to the periphery of the receiving portion and a second gas filled into the contents of the receiving portion. The first gas and the second gas may be the same or different and each independently may be one or more of carbon dioxide, nitrogen, oxygen, air, and other inert gases. For example, the first gas and the second gas may be carbon dioxide and nitrogen, air, or carbon dioxide, preferably carbon dioxide.

The first liquid beverage component includes water or water dissolved with carbon dioxide. The solid beverage component is one or more of milk powder, cola powder, protein powder, coffee powder, and other nutritional supplements. The second liquid beverage component is a liquid beverage component different from the first liquid beverage component.

During use, valve 40 is rotated to open, and the solid beverage ingredients or the second liquid beverage ingredients contained in second portion 43 are placed into first portion 42 and mixed with the first liquid beverage ingredients to form a beverage. The valve of temperature control portion 41 is opened to allow the liquefied gas therein to be filled into first portion 42 and/or its interlayer of the container, thereby cooling the beverage and producing a cold drink. Alternatively, the self-heating material package in temperature control portion 41 is mixed with water to produce an exothermic reaction, heating the container and heating the beverage to produce a hot drink.

The portable beverage preparation device of the present invention can conveniently prepare a solid-liquid dual-component beverage, and can prepare a cold drink after cooling or a hot drink after heating.

### Methods

### 1. Non-Energy-Dependent Temperature Control and Insulation Methods

For decentralized farming with a small number of dairy cows and low milk production, such as the traditional yak farming and production and processing methods in Tibet, and areas such as Africa where there is no centralized farming and large-scale production, a non-energy-dependent temperature control and insulation method is needed that is easy to move and can ensure the quality of raw milk.

The non-energy-dependent temperature control and heat preservation method according to the present invention mainly comprises utilizing the vaporization of liquefied gas or the sublimation of solidified gas to cool the object to be cooled.

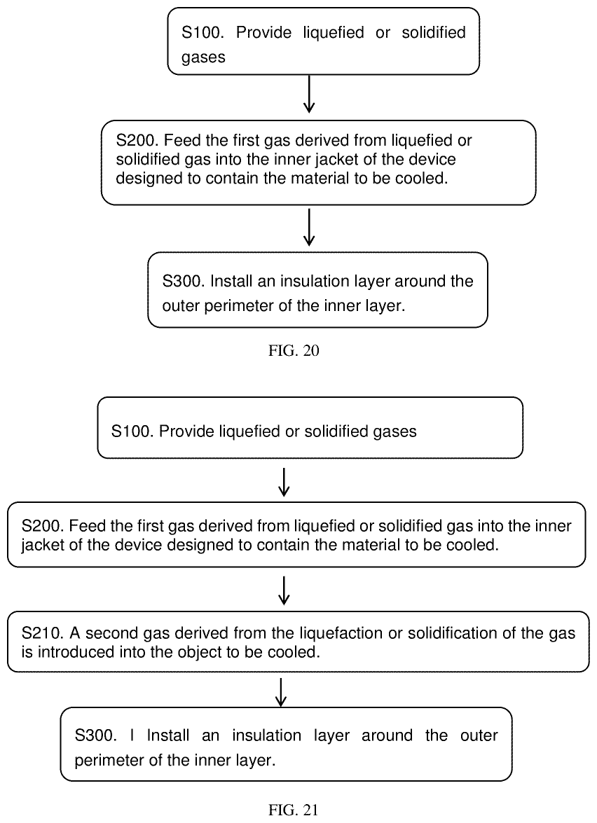

Referring to FIG. 20, according to one embodiment, the above-mentioned non-energy-dependent temperature control and heat preservation method includes the following steps:
S100. providing liquefied or solidified gas;
S200. inputting a first gas from a liquefied or solidified gas into the inner interlayer of the device receiving the object to be cooled, wherein the inner tube of the inner interlayer defines a receiving cavity receiving the object to be cooled;
S300. providing an insulation layer around the inner interlayer.

The gas used for liquefaction in the method of the present invention may be one or more of carbon dioxide, nitrogen, oxygen, air, and other inert gases, for example, carbon dioxide and nitrogen, air, or carbon dioxide, preferably carbon dioxide. Furthermore, the first gas may be one or more of the liquefied or solidified gases.

In the method of the present invention, the input of gas (e.g., carbon dioxide) is initiated at an appropriate time, for example, by opening a valve on a gas tank or a valve on a pipeline, and the gas is injected into the inner interlayer defining the containment cavity at an appropriate flow rate (e.g., 5 to 50 liters/minute). The liquefied gas absorbs a significant amount of heat during vaporization, cooling the contents of the containment cavity (i.e., the object to be cooled), preferably to below 20° C., for example, 4 to 20° C., 4 to 10° C., or 10 to 20° C.

Furthermore, the method of the present invention includes disposing an outer interlayer around the inner interlayer. Specifically, the outer interlayer can be a thermal insulation layer that is detachably disposed around the inner interlayer. The thermal insulation layer can include a layer of thermal insulation material, such as an insulation layer formed of a thermal insulation material, preferably a foam material layer.

After the insulation layer is provided, combined with the step of autonomous cooling of the gas filled in the inner interlayer, the temperature of the contents is reduced to below 20° C., and the quality of the raw milk can be maintained for a longer time.

Referring to FIG. 21, according to another embodiment of the present invention, a method for autonomous temperature regulation and heat preservation is provided, comprising the following steps:
S100. providing liquefied or solidified gas;
S200. inputting a first gas from a liquefied or solidified gas into the inner interlayer of the device receiving the object to be cooled, wherein the inner tube of the inner interlayer defines a receiving cavity receiving the object to be cooled;
S210. charging the object to be cooled with a second gas from a liquefied or solidified gas;
S300. providing an insulation layer around the inner interlayer.

Here, the definitions of the liquefied or solidified gas and the first gas are as defined above. The first gas and the second gas may be the same or different, but are preferably the same. Specifically, the second gas may be one or more of carbon dioxide, nitrogen, oxygen, air, and other inert gases, for example, carbon dioxide and nitrogen, air, or carbon dioxide, preferably carbon dioxide.

By injecting a specific gas into the raw milk, the injected gas dissolves in the raw milk, helping to inhibit the growth of microorganisms and prolong the quality of the raw milk. The amount of the second gas injected is such that the pH value of the raw milk reaches 6.0 to 6.2, for example, 6.1.

The second gas may be charged all at once or continuously during transportation to maintain the gas concentration in the raw milk within a set range, thereby preventing the concentration of gas dissolved in the raw milk from decreasing due to transportation shock.

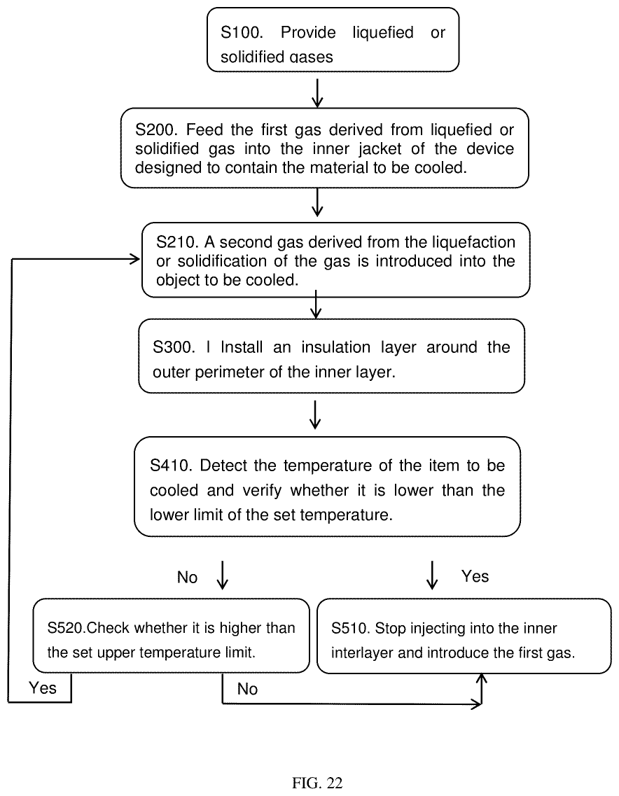

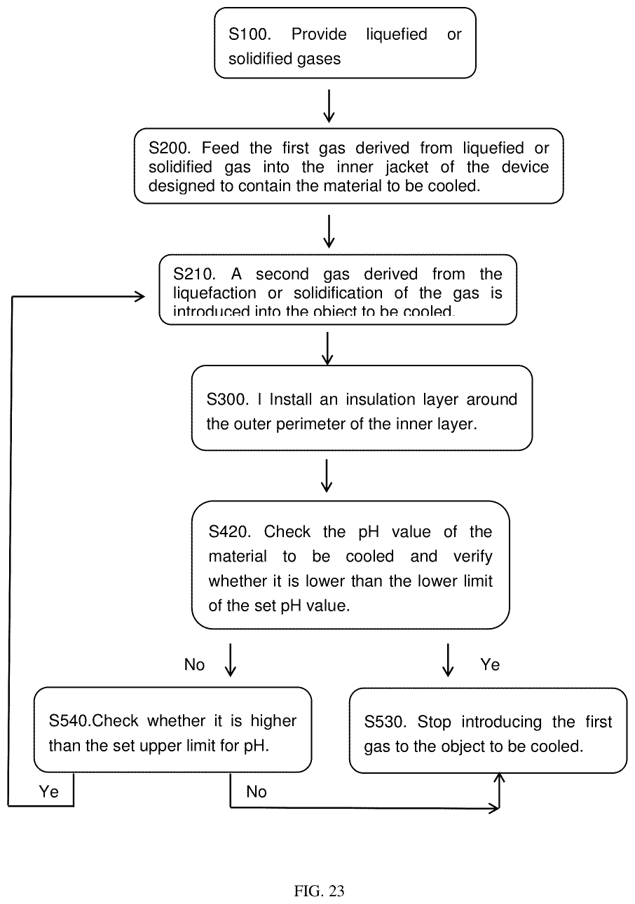

According to a third embodiment of the present invention, the autonomous temperature control and insulation method further includes monitoring one or both of the temperature and pH value of the object to be cooled. Referring to FIG. 22, when the monitored temperature of the object to be cooled is lower than a first set value (i.e., a lower set temperature limit, e.g., 4° C. or 10° C.) (S410), the supply of the first gas to the inner interlayer is stopped (S510). When the monitored temperature of the object to be cooled is higher than a second set value (i.e., an upper set temperature limit, e.g., 20° C.) (S520), the supply of the first gas to the inner interlayer is continued (S200). Referring to FIG. 23, when the monitored pH value of the object to be cooled is lower than a third set value (i.e., a lower set pH limit, e.g., 6.0) (S420), the supply of the second gas to the object to be cooled is stopped (S530). When the monitored pH value of the object to be cooled is higher than a fourth set value (i.e., an upper set pH limit, e.g., 6.2) (S540), the second gas is supplied to the object to be cooled (S210).

In this embodiment, by monitoring temperature and pH in real time and controlling the release and input direction of gas based on the monitoring results, the temperature and dissolved gas concentration of the contents can be autonomously adjusted, thereby ensuring the quality of the contents and extending their shelf life. For example, when the contents are raw milk, the protein content in the raw milk can be stabilized, the growth of microorganisms can be significantly reduced, and the spoilage of the raw milk can be delayed.

According to a fourth embodiment of the present invention, the autonomous temperature control and insulation method may further include placing ice cubes in the center of the contents to assist in lowering the temperature of the center of the contents. The ice cubes are produced using solar cooling, and ice trays containing the ice cubes are placed within the contents to assist in accelerating the cooling rate of the center of the contents.

According to a fifth embodiment of the present invention, the autonomous temperature control and heat preservation method of the present invention may further include a step of self-heating the processed object when necessary. Specifically, the self-heating step may utilize chemical energy from a chemical reaction to achieve continuous heating of the contents, thereby achieving autonomous temperature adjustment.

According to one specific embodiment, raw milk is continuously heated through an exothermic reaction between the first and second components and the heat released by the galvanic cell reaction. The first component, which can react exothermically with water, can be one or more of quicklime, aluminum powder, and iron powder. The heat generated by these components reacting with water rapidly raises the water temperature until water vapor is generated. The second component can be one or more of diatomaceous earth, coke, and activated carbon. Their porous structure facilitates the adhesion of other components and promotes full contact and chemical reaction between components.

This embodiment utilizes the exothermic reaction of the above components with water, as well as the “galvanic cell” effect formed with oxygen, water, and salt to continuously release heat and achieve continuous self-heating.

### 2. Milk Collection and Temperature Adjustment Method

According to one embodiment, the present invention also provides a method for collecting milk and adjusting milk temperature, comprising:
supplying power to a motor and driving the motor so that a milking unit connected to the motor milks the cow to obtain raw milk; and
transporting the raw milk to a temperature regulation and heat preservation device that is not energy-dependent, and the raw milk being cooled by vaporizing liquefied gas or sublimating solidified gas.

Wherein, supplying power to the motor includes supplying power to the motor using a power generation unit, wherein the power generation unit includes a power generation element selected from a solar panel and a wind turbine and an energy storage battery pack.

The milk collection and temperature control method further comprises one or both of filtering and auxiliary temperature control of the raw milk before the gas cooling step.

The auxiliary temperature regulation includes the power generation unit supplying power to the electrically driven semiconductor cooling device or the heat exchange component, thereby cooling the raw milk.

The above-mentioned milk collection and temperature control method may also include setting up a sensor module and communicating with the temperature control and insulation device to monitor the position of the cow, the health status of the cow, the temperature of the raw milk, the pH value of the raw milk, the antibiotic content of the raw milk, the microbial content of the raw milk and one or more of the milk-specific proteins in the raw milk.

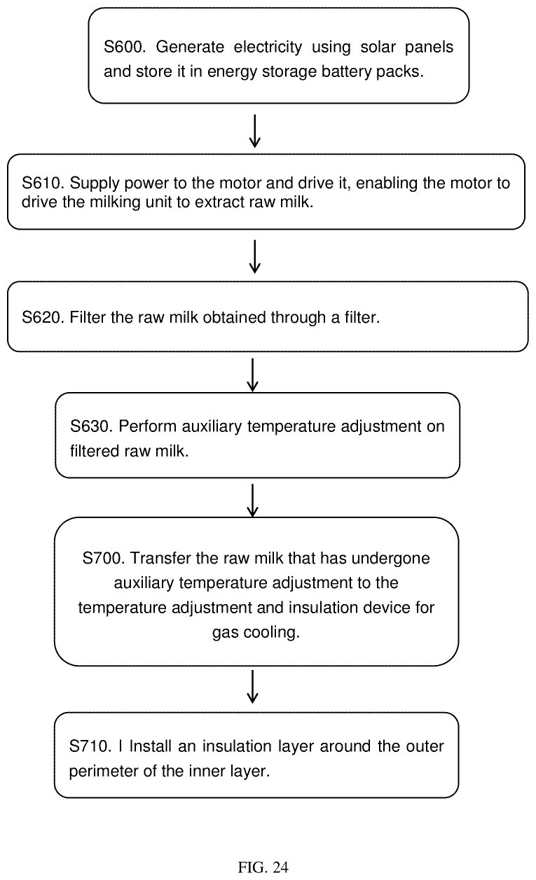

Referring to FIG. 24, a milk temperature adjustment method according to a specific embodiment includes:
S600. generating electricity using solar panels and storing it in energy storage batteries;
S610. powering the motor and driving the motor so that the motor drives the milking unit to milk and obtain raw milk;
S620. filtering the obtained raw milk through a filter;
S630. utilizing semiconductor devices or heat exchange units to assist in temperature control of filtered raw milk;
S700. transporting the raw milk after auxiliary temperature adjustment to the temperature adjustment and insulation device for gas cooling;
S710. using sensor elements to detect parameters such as temperature and pH value of raw milk.

The milk collection and temperature control method of the present invention adopts a fully enclosed operation mode, which avoids exposure of raw milk, reduces impurities and bacteria that may be introduced, and makes full use of solar energy and wind energy for clean power generation. It provides a very good milk collection and temperature reduction method for pastoral areas without centralized milk collection bases, improves the efficiency of collecting raw milk, improves the quality of raw milk, and extends the shelf life.

### 3. Grazing Milking Monitoring and Management Methods

According to another embodiment, the present invention also provides a grazing and milking monitoring and management method, comprising the steps of the following:
selecting pastoral areas and confirming pastoral area information;
receiving the number of dairy cows in the selected pasture and location information of each dairy cow;
checking whether the positioning information is within the stored selected pastoral area; and
determining whether to send a control signal based on the check result, wherein the control signal is used to control the status of the cow.

The above-mentioned grazing and milking monitoring and management method further includes: if the positioning location of the dairy cow exceeds the range of the selected grazing area, sending a control signal to the dairy cow to prompt the dairy cow to return to the range of the selected grazing area or the distribution center;
if the positioning location of the dairy cow does not exceed the range of the selected pasture area, continuing to receive the collection and storage information of the raw milk, and determining whether the received collection and storage information exceeds the preset range;
if the collected and stored information received exceeds the preset range, a control signal being sent to the cows to prompt them to return to the distribution center;
wherein, the collected and stored information includes the power supply of the milking device, the health status of the cows, the amount of raw milk stored in the temperature control and insulation device, the milk temperature and the storage amount of liquefied gas, and one or more of the various physical and chemical indicators of the raw milk.

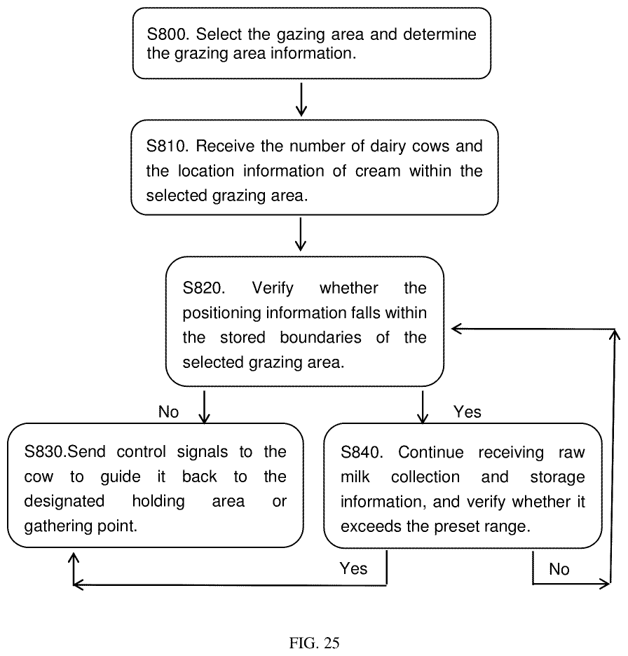

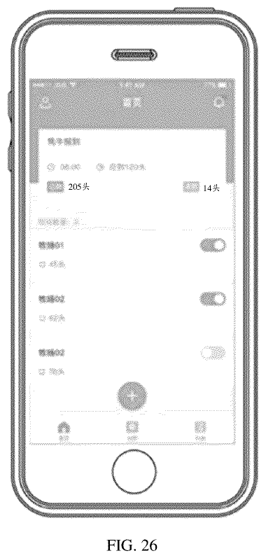

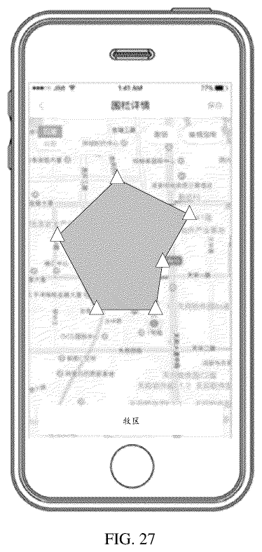

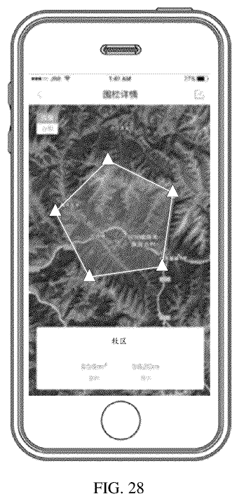

Referring to FIG. 25, a grazing and milking monitoring and management method according to a specific embodiment includes:
S800. selecting a pastoral area and confirming the pastoral area information, as shown in FIG. 26;
S810. receiving the number of cows in the selected pasture and the location information of each cow, as shown in FIG. 27;
S820. checking whether the positioning information is within the stored selected pastoral area, as shown in FIG. 28;
S830. if the location information of the cow is not within the pre-stored selected grazing area, sending a control signal to the cow, such as an electric shock or an alarm, to prompt the cow to return to the selected grazing area or the distribution center;
S840. if the positioning information of the dairy cow is within the pre-stored selected pastoral area, continuing to receive the raw milk collection and storage information to check whether it exceeds the preset range.

If the verified raw milk collection and storage information exceeds the preset range, step S830 is executed to send a control signal to the cow to prompt the cow to return to the selected pasture area or distribution center.

In step S840, if the verified raw milk collection and storage information does not exceed the preset range, step S820 is executed again to verify the cow's location information.

The above-mentioned grazing and milking monitoring and management method of the present invention makes it easy for herders to view pasture information, basic information, current location, and health status of dairy cows (especially yaks), navigate and track dairy cows, and track changes in the quality of collected raw milk.

On the other hand, the present invention also provides a grazing and milking monitoring and management device, comprising:
a receiving module, used to receive information to be processed related to dairy cows, milking devices, and temperature control and insulation devices;
a checking module, used to check the to-be-processed information related to the dairy cow, the milking device and the temperature regulation and heat preservation device with corresponding preset values, and determine whether a control signal needs to be sent;
a sending module, used to send a control signal to prompt the cows to return to the selected pasturing area or distribution center.

According to yet another embodiment, the present invention further provides an electronic device, comprising:
a processor; and
a memory communicatively connected to the processor.

The memory stores instructions that can be executed by the processor, and the instructions are executed by the processor so that the processor can execute the above-mentioned grazing and milking monitoring and management method.

According to yet another embodiment, the present invention further provides a non-transitory computer-readable storage medium storing computer instructions, wherein the computer instructions are used to enable the computer to execute the above-mentioned grazing milking monitoring and management method.

According to yet another embodiment, the present invention further provides a computer program product, comprising a computer program, wherein when the computer program is executed by a processor, the computer program implements the above-mentioned grazing and milking monitoring and management method.

The specific embodiments of the present invention will be described in detail below through examples, but the present invention is not limited thereto.

### Example 1

The temperature regulation and heat preservation device in this embodiment is a milk transport bucket, comprising the following structure: a gas tank, a barrel body, and a lid. The barrel body comprises an inner and outer interlayer. The inner interlayer, made of polypropylene (PP) and containing a hollow cavity, is a polypropylene outer shell filled with polystyrene foam. The hollow structure is connected to the gas tank, sharing a common main pipe. A thermometer and a pH meter are located within the hollow structure. The gas tank stores liquefied carbon dioxide.

25 kg of fresh milk at 35° C. was placed in the chamber. Carbon dioxide gas was introduced into the inner layer until the temperature of the milk dropped to 4° C. and the pH value was 6.8. The milk was then stored at 4° C. for 6 days.

### Example 2

The temperature regulation and insulation device in this embodiment is a milk transport bucket with the following structure: a gas tank, a barrel body, and a lid. The barrel body comprises an inner and outer interlayer. The inner interlayer, made of polypropylene (PP) and containing a cavity, has a hollow structure. The outer interlayer consists of a PP outer shell filled with polystyrene foam. The hollow structure and the cavity are connected to the gas tank through a common main pipe. A thermometer and a PH meter are installed in the hollow structure. The gas tank stores liquefied carbon dioxide.

The chamber was filled with 25 kg of fresh milk at 35° C. Carbon dioxide was introduced into the inner layer until the temperature of the milk dropped to 4° C. Carbon dioxide was then added to the milk until the pH reached 6.1. The milk was then stored at 4° C. for 6 days.

### Example 3

The temperature regulation and insulation device in this embodiment is a milk transport bucket with the following structure: a gas tank, a barrel body, and a lid. The barrel body comprises an inner and outer interlayer. The inner interlayer, made of polypropylene (PP) and containing a cavity, has a hollow structure. The outer interlayer consists of a PP outer shell filled with polystyrene foam. The hollow structure and the cavity are connected to the gas tank through a common main pipe. A thermometer and a PH meter are installed in the hollow structure. The gas tank stores liquefied carbon dioxide.

A chamber was filled with 25 kg of fresh milk at 35° C. Carbon dioxide was introduced into the inner chamber until the temperature of the milk dropped to 4° C. Carbon dioxide was then introduced into the chamber until the pH reached 6.1. Carbon dioxide was introduced briefly (approximately 5 minutes) every 24 hours to maintain a pH of 6.1. The milk was then stored at 4° C. for 6 days.

### Example 4

The temperature regulation and heat preservation device in this embodiment is a milk transport bucket with the following structure: an air tank, a barrel body, and a lid. The barrel body comprises an inner and outer interlayer. The inner interlayer, made of polypropylene (PP) and containing a cavity, has a hollow structure. The outer interlayer consists of a PP outer shell filled with polystyrene foam. The hollow structure and the cavity are connected to the air tank through a common main pipe. A thermometer and a pH meter are installed in the hollow structure. The air tank stores liquefied air.

Fill a holding chamber with 25 kg of fresh milk at 35° C. Aerate the inner chamber until the milk's temperature drops to 4° C. Aerate the milk until its pH reaches 6.2. Briefly aerate the milk (approximately 5 minutes) every 24 hours to maintain a pH of 6.2. Store the milk at 4° C. for 6 days.

The fresh milk stored according to Examples 1 to 4 was tested for total protein, total fat and microbial count on the 0th and 6th days of storage, and the measured results are shown in Table 1 below.

The analysis method is as follows:
Total protein: determined according to GB5009.5;
Total fat: determined according to GB5009.6-2016;
Total colony count (microorganism count): determined according to GB4789.2;
pH value: pH meter, Beckman pH meter.

TABLE 1

| | pH | | Total protein | | Total fat | | Total colony | |
|---|---|---|---|---|---|---|---|---|
| | (g/100 mL) | | (g/100 mL) | | (CFU/mL) | | count | |
| Sample | D 0 | D 6 | D 0 | D 6 | D 0 | D 6 | D 0 | D 6 |
| Example 1 | 6.8 | 6.6 | 3.03 | 2.99 | 3.14 | 3.10 | 320 | 1.7 × 10 8 |
| Example 2 | 6.1 | 6.1 | 3.03 | 2.83 | 3.14 | 3.01 | 301 | 7.5 × 10 7 |
| Example 3 | 6.1 | 6.1 | 3.03 | 2.92 | 3.14 | 3.09 | 335 | 3.8 × 10 5 |
| Example 4 | 6.2 | 6.2 | 3.03 | 2.89 | 3.14 | 3.06 | 328 | 4.5 × 10 6 |

Based on Examples 1 to 4 and Table 1, Example 1, where the fresh milk was not carbonated, had a higher pH. Carbonation in Example 2 to 4 reduced the pH. After 6 days of storage, the total protein content of the sample in Example 1 (not carbonated or aired) remained unchanged. However, the total protein content of the samples in Examples 2 to 4 (one-time carbonation in Example 2, continuous intermittent carbonation in Example 3, and continuous intermittent carbonation in Example 4) decreased slightly, due to a small amount of protein hydrolysis. Regarding the total bacterial count (i.e., the number of microorganisms), the sample in Example 1, which was not carbonated or aired, showed a significant increase in the number of microorganisms in the fresh milk. Compared to the sample in Example 1, the sample in Example 2, which was carbonated once, had a significantly lower total bacterial count, indicating that dissolved carbon dioxide in the fresh milk helps inhibit bacterial growth. The total bacterial count in the sample in Example 3 was further reduced compared to the sample in Example 1, as the carbon dioxide concentration in the fresh milk was maintained. The total bacterial count in the sample in Example 4 decreased, but to a lesser extent than in Examples 2 and 3, due to the relatively low carbon dioxide content in the air.

Carbon dioxide affects the growth and metabolism of microorganisms in at least three different ways: it replaces oxygen with carbon dioxide; it lowers the pH of fresh milk due to the dissolution of carbon dioxide and the formation of carbonic acid; and it has a direct inhibitory effect on microbial metabolism, including changes in membrane fluidity, a decrease in intercellular pH, and direct inhibition of metabolic pathways.

It should be understood that the various forms of the processes shown above can be used to reorder, add, or delete steps. For example, the steps described in the present invention can be performed in parallel, sequentially, or in a different order, as long as the desired results of the technical solutions disclosed in the present invention can be achieved. This is not limited herein.

The above specific embodiments do not limit the scope of protection of the present invention. Those skilled in the art will appreciate that various modifications, combinations, sub-combinations, and substitutions may be made based on design requirements and other factors. Any modifications, equivalent substitutions, and improvements made within the spirit and principles of the present invention are intended to be included within the scope of protection of the present invention.

1. A non-energy-dependent temperature regulation and heat preservation device, comprising a non-energy-dependent temperature regulation portion and a gas storage portion;
wherein, the temperature regulation portion includes:
an inner interlayer;
an outer interlayer surrounding the inner interlayer; and
a receiving cavity defined by the inner interlayer;
wherein, the inner interlayer is communicated with the gas storage portion.

2. The temperature regulation and heat preservation device according to claim 1, wherein the gas storage portion is detachably connected to the temperature regulation portion.

3. The temperature regulation and heat preservation device according to claim 1, wherein the outer interlayer is filled with a heat-conducting material or a heat-insulating material.

4. The temperature regulation and heat preservation device according to claim 1, wherein the inner interlayer has a hollow structure for being filled with a first gas.

5. The temperature regulation and heat preservation device according to claim 1, wherein the gas storage portion contains one or more liquefied or solidified gases selected from carbon dioxide, nitrogen, oxygen, air, butane, isobutane, propane and other inert gases.

6. The temperature regulation and heat preservation device according to claim 1, wherein the receiving cavity is provided with one or more of a temperature testing element, a pH testing element, an antibiotic content testing element, a microbial content testing element, a milk-specific protein testing element and a gravity sensor.

7. The temperature regulation and heat preservation device according to claim 4, wherein the gas storage portion is connected to an air inlet of the hollow structure of the inner interlayer.

8. The temperature regulation and heat preservation device according to claim 4, wherein the air inlet of the receiving cavity is connected to one or both of the air outlets of the gas storage portion and the hollow structure of the inner interlayer.

9. The temperature regulation and heat preservation device according to claim 4, wherein an exhaust port of the hollow structure of the inner interlayer is connected to one or more of a first filter component, a muffler, a centrifugal component and a gas recovery adsorption device.

10. The temperature regulation and heat preservation device according to claim 8, wherein:
a second filter component is provided between the air inlet of the receiving cavity and the exhaust port of the hollow structure of the inner interlayer, preferably, a second filter component is a bacterial filter component.

11. The temperature regulation and heat preservation device according to claim 1, wherein the inner interlayer has an inner pillow-plate jacketed structure.

12. The temperature regulation and heat preservation device according to claim 9, wherein the first filter component is a negative pressure filter assembly or a positive pressure filter assembly;
preferably, the negative pressure filter assembly includes a first funnel having a first branch pipe, and a vacuum generator connected to the first branch pipe, the air inlet of the vacuum generator is connected to the exhaust port of the hollow structure of the inner interlayer or an independent air source, and the exhaust port is connected to a muffler or a gas recovery adsorption device;
the positive pressure filter assembly includes a second funnel with a second branch pipe and a top cover that seals the second funnel, the top cover is connected to the exhaust port of the hollow structure of the inner interlayer or an independent air source, and the second branch pipe is connected to a muffler or a gas recovery adsorption device.

13. The temperature regulation and heat preservation device according to claim 1, further comprising an auxiliary temperature regulation component for cooling or heating the receiving cavity.

14. The temperature regulation and heat preservation device according to claim 13, wherein the auxiliary temperature regulation component is selected from an electrically driven semiconductor cooling device and a heat exchange component.

15. The temperature regulation and heat preservation device according to claim 4, wherein the exhaust port of the hollow structure of the inner interlayer is located below the surface of the contents, and the temperature regulation and heat preservation device further comprises a check valve.

16. The temperature regulation and heat preservation device according to claim 4, wherein the exhaust port of the hollow structure of the inner interlayer is located above the surface of the contents, and the temperature regulation and heat preservation device further comprises a drain pipe, a liquid inlet of the drain pipe is located at the bottom of the receiving cavity, and a check valve is provided.

17. A non-energy-dependent temperature regulation and heat preservation method, characterized in that it comprises utilizing the vaporization of liquefied gas or the sublimation of solidified gas to cool the object to be cooled.

18. The temperature regulation and heat preservation method according to claim 17, comprising the steps of:
providing a gas storage portion for storing liquefied or solidified gas;
the gas being fed into the inner interlayer of the device receiving the object to be cooled by vaporizing the liquefied gas or sublimating the solidified gas; and
a heat-insulating layer being arranged on the periphery of the inner interlayer.

19. The temperature regulation and heat preservation method according to claim 18, wherein the liquefied gas and the solidified gas are independently selected from one or more of carbon dioxide, nitrogen, oxygen, air, butane, isobutane, propane and other inert gases.

20. The temperature regulation and heat preservation method according to claim 17, further comprising the steps of:
the gas being injected into the receiving cavity defined by the inner interlayer, preferably, the gas coming from the hollow structure of the inner interlayer or the gas storage portion.
